(19) United States
(12) Patent Application Publication
(10) Pub. No.: US 2002/0065690 A1
(43) Pub. Date: May 30, 2002

(54) Method, system, and computer program product for evaluation of the proximity of brands and vehicles

(76) Inventor: Kazuya Kusumoto, Tokyo (JP)

Correspondence Address: STAAS & HALSEY LLP, 700 11TH STREET, NW, SUITE 500, WASHINGTON, DC, 20001, US

(21) Appl. No.: 09/784,133

(22) Filed: Feb. 16, 2001

(30) Foreign Application Priority Data
Oct. 4, 2000 (JP) 2000-305010

(51) Int. Cl. G06F 17/60

(52) U.S. Cl. 705/7

(57) ABSTRACT

A method is provided which enables the objective, rapid, and highly reliable evaluation of the proximity of brands and vehicles. The evaluation method evaluates the proximity of a brand and/or a vehicle based on factors obtained as a result of factor analysis of a brand group and/or a vehicle group, and, in a coordinate space in which the plural factors are taken to be axes with the origin taken to be the factor score=0, and the factor score of each brand and/or each vehicle for each factor is represented as a distance from the origin on the factor axis, evaluates mutual proximities by considering the magnitude of the angle θ made between vectors, or by considering the angle θ and distances.

### BACKGROUND OF THE INVENTION

1. Field of the Invention

The invention of this application concerns technology for the quantitative evaluation of the affinity of a vehicle with a specific brand, of the affinity of a brand with a specific vehicle, of the proximity of a specific brand to another brand, and of the proximity of a specific vehicle to another vehicle, taking as basic data the utilization of brands and vehicles by consumers and the affirmation or negation of the sense-of-values statements by consumers.

Hereupon, in the Specification of this application, there are cases in which “affinity” is evaluated as high when there is high “proximity”, and so in the Specification of this application, there are cases in which “proximity” also means “affinity”.

Also, because the content of this invention is a technological concept closely related to commercial activities, an explanation cannot avoid the necessity of citing specific brands and vehicles. Hence in this Specification, symbols such as ∘, Δ, A, B, C are frequently used. However, these symbols do not have a specific meaning, nor do symbols used in one explanation necessarily have the same meaning as the same symbols used in the explanation in another place.

In this Specification, “brand” is an appellation for a specific commodity or service, or for a group of commodities or services, which enable discrimination from other commodities or services; it is a concept which includes entities publicly and generally recognized as brands and trademarks, besides those registered as trademarks according to trademark law, and specifically includes whiskey trademarks, brand names (such as “ABC 15 years”), and automobile names.

For example, if all the automobiles manufactured by an automobile manufacturer (company ∘∘∘) are of the brand “∘∘∘”, a specific model is of the brand “ΔΔΔ”, and a deluxe version is called “ΔΔΔ-DX”, each of these can be adopted for evaluation as brands. In this case, the evaluator can freely determine adoption for evaluation.

Similarly, if all the cosmetics manufactured by a cosmetics producers (company ∘∘) are of the brand “∘∘”, and a specific cosmetic (for example, lipstick) is of the brand “ΔΔ”, then each of these can also be adopted for evaluation as brands.

Also, in this Specification, “vehicle” signifies an entity which supplies space to display advertisements to consumers and other targeted persons.

Specifically, vehicles include television programs, dayparts for television, radio programs, dayparts for radio, magazines, newspapers, public transportation routes, public transportation embarkation/disembarkation points, transfer facilities (stations, airports, boat landings), Internet sites (web pages and similar), and other entities. That is, vehicles are such things as ∘∘ newspaper, ΔΔ newspaper, and area along ∘∘ transportation route, as well as individual entities such as ∘∘ station and ΔΔ station.

Hence the term “vehicle” used in this Specification does not refer solely to magazines, newspapers and other advertising media, as is frequently the case when the word is used in English.

Moreover, the above-described “space” includes physical space, temporal space, and conceptual or virtual space. In terms of the above examples, public transportation routes, the embarkation/disembarkation points of public transportation, and relay facilities are examples of entities which provide physical space; the broadcasting dayparts of television are examples of entities which provide temporal space; and Internet sites are examples of entities providing conceptual or virtual space.

Here “commodities” is a concept which includes intangible as well as tangible items.

Furthermore, a brand can simultaneously be a vehicle as well. For example, a magazine can be a vehicle for the purpose of promoting some kind of commodities, and at the same time can itself be a brand as referenced in this invention.

2. Description of the Related Art

Various conventional methods to evaluate the mutual proximity of a brand and/or a vehicle are known, which take both extremes: methods for obtaining a subjective understanding through the sensibilities of the evaluating persons, and methods for objective evaluation of the proximity of a brand and/or a vehicle based on factor categories obtained as the result of multivariate analysis of a brand and/or a vehicle.

The latter are methods in which the proximity of each brand or vehicle to a certain factor is evaluated as the distance along the factor axis; of course because such methods depend little on the subjective views of the evaluator, they are in principle superior.

However, the result of such an evaluation is not infrequently at variance with the intuitive proximity or affinity, so that under present conditions the result must be modified by the subjective judgment of humans.

### SUMMARY OF THE INVENTION

The problem to be solved by the invention of this application is to provide a method for evaluation of the proximity of each brand or vehicle to a certain factor which is of higher reliability, enabling easier execution of evaluation, and which is easier to understand.

That is, the present invention is as follows.

1. A method of evaluation of the proximity of a brand and/or a vehicle, based on factors obtained as a result of factor analysis of a brand group and/or a vehicle group, and comprising

evaluation of the mutual proximity between brands, or between vehicles, or between a brand and a vehicle, through the magnitude of the angle θ formed by the vectors thereof, in a coordinate system in which a plurality of factors are respectively taken to be axes with the origin taken to be the factor score=0, and the factor score of each brand and/or each vehicle for each factor is expressed as a distance from the origin along the factor axis.

2. The method of evaluation of the proximity of a brand and/or a vehicle according to 1. above, comprising the evaluation of mutual proximity by means of the magnitude of the angle θ made by the above-described vectors and their mutual distance.

3. A method of evaluation of the proximity of a brand and/or a vehicle, based on factors obtained as a result of factor analysis of a brand group and/or a vehicle group, wherein

in a coordinate system in which a plurality of factors are respectively taken to be axes with the origin taken to be the factor score=0, and the factor score of each brand and/or vehicle for each factor is expressed as a distance from the origin along the factor axis, the mutual proximity of a specific brand or vehicle lᵢ and a specific brand or vehicle mⱼ is evaluated by means of equation (1) below.

$${D}_{ij} = {[ α \{ {\sum }_{k = 1}^{n} {( {l}_{ik} - {m}_{jk} )}^{2} \} + {β ( 1 - cos {θ}_{ij} )}^{2} ]}^{1 / 2} \qquad ( 1 )$$

where:

i, j: Numbers assigned to brands or vehicles

Dᵢⱼ: Value distance between brand or vehicle lᵢ, and brand or vehicle mⱼ

lᵢₖ: Factor score on the k-factor axis of brand or vehicle lᵢ

mⱼₖ: Factor score on the k-factor axis of brand or vehicle mⱼ

n: Number of factor axes used in evaluation

θᵢⱼ: Angle made by the vectors of the brand or vehicle lᵢ, and the brand or vehicle mⱼ

α, β: Weighting factors, where 0≦α≦1 and 0<β≦1

4. The proximity evaluation method according to 3. above, wherein 2α≦β.

5. The proximity evaluation method of 3. or 4. above, wherein α=0.05 to 0.4, and β=0.95 to 0.6.

6. A method of evaluation of the proximity of a vehicle to a brand, which determines the affinity of each of the vehicles in a selected vehicle group with a specific brand by means of the angle θ of the above 1. or of the angle θ and distance of the above 2. or of the value distance Dᵢⱼ of any of the above 3. through 5. formed by each of the vehicles of the selected vehicle group and the specific brand.

7. A method of evaluation of the proximity of a brand to a vehicle, which determines the affinity of each of the brands in a selected brand group with a specific vehicle by means of the angle θ of the above 1. or of the angle θ and distance of the above 2. of or the value distance Dᵢⱼ of any of the above 3. through 5. formed by each of the brands of the selected brand group and the specific vehicle.

8. A method of evaluation of the proximity of a brand to a brand, which determines the proximity of each of the brands in a selected brand group with a specific brand by means of the angle θ of the above 1. or of the angle θ and distance of the above 2. or of the value distance Dᵢⱼ of any of the above 3. through 5. formed by each of the brands of the selected brand group and the specific brand.

9. A method of evaluation of the proximity of a vehicle to a vehicle, which determines the proximity of each of the vehicles in a selected vehicle group with a specific vehicle by means of the angle θ of the above 1. or of the angle θ and distance of the above 2. or of the value distance Dᵢⱼ of any of the above 3. through 5. formed by each of the vehicles of the selected vehicle group and the specific vehicle.

10. The method of proximity evaluation of any of 1. through 8. above, wherein the brand or brand group is at least one selected from the group consisting of an automobile brand or brand group, a cosmetic brand or brand group, or an alcoholic beverage brand or brand group.

11. The method of proximity evaluation of any of 1. through 7. or 9. above, wherein the vehicle or vehicle group is at least one selected from the group consisting of a magazine or magazine group, or a newspaper or newspaper group.

12. A method of evaluation of the proximity of a brand and/or a vehicle, based on factors obtained as a result of factor analysis of a brand group and/or a vehicle group, and comprising

evaluation of the proximity between brands or between vehicles through the magnitude of the angle formed by factor scores and a factor axis, in a coordinate system in which a plurality of factors are respectively taken to be axes with the origin taken to be the factor score=0, and the factor score of each brand and/or each vehicle for each factor is expressed as a distance from the origin along the factor axis.

13. The method of evaluation of the proximity of a brand and/or a vehicle according to 12. above, comprising the evaluation of proximity by means of the magnitude of the angle made by factor scores and a factor axis, and the distance between the factor score and the origin.

14. A system for evaluation of the proximity of a brand and/or a vehicle, based on factors obtained as a result of factor analysis of a brand group and/or a brand group, and having

means for determining factor scores of each brand and/or vehicle for each factor of a plurality of factors, and,

in a coordinate system in which the plural factors are taken to be axes with the origin taken to be the factor score=0, and the factor score of each brand and/or vehicle for each factor is expressed as a distance from the origin along the factor axis, means for generation of the angles of vectors formed between coordinate points determined by the factor scores of each brand and/or each vehicle.

15. A system for evaluation of the proximity of a brand and/or a vehicle, based on factors obtained as a result of factor analysis of a brand group and/or a brand group, and having

means for determining factor scores of each brand and/or vehicle for each factor of a plurality of factors, and,

in a coordinate system in which the plural factors are taken to be axes with the origin taken to be the factor score=0, and the factor score of each brand and/or vehicle for each factor is expressed as a distance from the origin along the factor axis, means for generation of the angles formed between coordinate points determined by the factor scores of each brand and/or each vehicle, and factor axes.

16. The system for proximity evaluation according to 14. or 15. above, having means for generation of distances between coordinate points and/or distances between coordinate points and the origin.

17. A system for evaluation of the proximity of a brand and/or a vehicle, based on factors obtained as a result of factor analysis of a brand group and/or a brand group, and having

means for determining factor scores of each brand and/or vehicle for each factor of a plurality of factors, and,

in a coordinate system in which the plural factors are taken to be axes with the origin taken to be the factor score=0, and the factor score of each brand and/or vehicle for each factor is expressed as a distance from the origin along the factor axis, means for generation of the mutual proximity between a specific brand or vehicle lᵢ and a specific brand or vehicles mⱼ, using equation (1) below.

$${D}_{ij} = {[ α \{ {\sum }_{k = 1}^{n} {( {l}_{ik} - {m}_{jk} )}^{2} \} + {β ( 1 - cos {θ}_{ij} )}^{2} ]}^{1 / 2} \qquad ( 1 )$$

where:

i, j: Numbers assigned to brands or vehicles

Dᵢⱼ: Value distance between brand or vehicle lᵢ, and brand or vehicle mⱼ

lᵢₖ: Factor score on the k-factor axis of brand or vehicle lᵢ

mⱼₖ: Factor score on the k-factor axis of brand or vehicle mⱼ

n: Number of factor axes used in evaluation

θᵢⱼ: Angle made by the vectors of the brand or vehicle lᵢ, and the brand or vehicle mⱼ

α, β: Weighting factors, where 0≦α≦1 and 0<β≦1

18. A computer program product for executing the method according to any one of the above 1. through 9., 12. or 13.

The invention of this application is a method for quantitative evaluation of the affinity of a vehicle with a specific brand, of the affinity of a brand with a specific vehicle, of the proximity of a specific brand to another brand, and of the proximity of a specific vehicle to another vehicle, taking as basic data the utilization of brands and vehicles by consumers and the affirmation or negation of the sense-of-values statements by consumers.

That is, in this method the brands and vehicles of this invention are selected, and taking as basic data the utilization of these by consumers and the affirmative or negative response by consumers to the sense-of-values statements, this data is used to determine factors, to determine factor scores as the distance from the origin along each factor axis for each brand and vehicle, and, in a coordinate system which takes each factor as an axis, to evaluate the mutual proximity and affinity by means of the angles made by each of the brands and/or vehicles and the distances.

Here factor analysis is one method of multivariate analysis, and the various known methods can be used. For example, the varimax method, the quartimax method, and the bi-quartimax method, can be used.

In the invention of this application, a “factor” is a set of the same attributes having mutual resemblance of sense-of-values statements; if conditions are stipulated, the number of factors can be determined automatically using multivariate analysis. Factors generated in this way are a group of sense-of-values statements.

“Sense-of-values statements” are, in factor analysis, normally called variables, and are items or statements indicating various sense of values held by people; specific examples by genre are shown in Table 1. Items or statements other than those in this table can be freely specified.

In the above evaluations of proximity and affinity, it was discovered that the introduction of the concept of angles or vector angles is extremely useful.

This may be explained in greater detail as follows.

FIG. 1 is a model diagram showing a comparison of the conventional method and the evaluation method of this invention introducing the concept of angles.

In FIG. 1, the horizontal axis is the axis of factor 1, and the vertical axis represents the axis of factor 2; vehicle x₁, vehicle x₂, and brand a₁ are plotted in a plane-orthogonal coordinate system by distances from the origin along the factor 1 axis (x₁₁, x₂₁, a₁₁) and by distances from the origin along the factor 2 axis (x₁₂, x₂₂, a₁₂).

The vehicle x₁, vehicle x₂, and brand a₁ correspond to the lᵢ and mⱼ explained above, with i=1 and j=1,2. In order to clarify the distinction between vehicles and brands, instead of l or m, x and a are used.

Conventionally, in this drawing, proximity is evaluated through distances obtained using terms such as |x₁₁-a₁₁|, |x₂₁-a₁₁|, |x₁₂-a₁₂|, |x₂₂-a₁₂|, [(x₁₁-a₁₁)²+(x₁₂-a₁₂)²]^{½}, and [(x₂₁-a₁₁)²+(x₂₂-a₁₂)²]^{½}.

In the invention of this application, the concept of angles (vector angles) represented by θ₁ and θ₂ in FIG. 1 is introduced; in this method, proximity is evaluated using the magnitude of these angles, or using relations between angles and distances.

In the example of FIG. 1, in terms of distances, the above two vehicles should have equivalent proximity to the brand a₁, but in terms of the factor 1 axis, vehicle x₂ has closer proximity with respect to factor b 1 than does vehicle x₁ (that is, |a₁₁-x₂₁| is shorter than |a₁₁-x₁₁|), and in terms of the factor 2 axis, vehicle x₁ has closer proximity than does vehicle x₂ with respect to factor 2 (that is, |a₁₂-x₁₂| is shorter than |a₁₂-x₂₂|).

Thus in the conventional method, it is sometimes not possible to perform objective evaluation. Yet, there are occasions in such circumstances that a clear difference between the two was recognized when concretely evaluating the absorption of a brand message by means of promotional campaigns for both vehicles.

Compared with this, when the angles of this invention are introduced, in the example of FIG. 1 the angle made with the brand a₁ is smaller for the vehicle x₁ than for the vehicle x₂, showing closer proximity. That is, the proximity between the vehicle x₁ and the brand a₁ is closer than the proximity between the vehicle x₂ and the brand a₁, so that the vehicle x₁ has closer proximity to the brand a₁ than does the vehicle x₂.

It was discovered that this is in good agreement with concrete evaluations like that above.

Further, through combined use of this concept of angles and the concept of distances, accuracy is improved.

As methods for this combination, appropriate application of common mathematical processings is also possible; in particular, however, it was discovered that eq. (1) above is superior.

That is, the value-distances of this invention are distances which include the concept of angles. In this case, lᵢₖ and mⱼₖ may both concern either brands or vehicles.

The explanation of the above FIG. 1 is for two coordinate axes; but as indicated by eq. (1), this invention enables evaluations employing two or more factor axes.

A schematic representation of this invention appears as the flowchart of FIG. 2.

In FIG. 2, step 1 represents the data collection process.

In data collection, a survey was made to a group of persons targeted for the survey who have been selected by a specific method, to show a list of brands, vehicles and sense-of-values statements, and asked about utilization of each brand, utilization of each vehicle, and for an affirmation or negation of the sense-of-values statements.

Here it is possible to either consider or exclude from consideration the age, sex, occupation, income, marital status, geographic region, and other demographic characteristics of the group of targeted persons, and trial-and-error can also be used for the selection.

In place of questions asking whether each brand is known, questions may for example ask, with respect to beverage brands, whether the person “drank in last several weeks or months” or “purchased in last several weeks or months” the beverage. That is, the question should address utilization by the targeted person.

Similarly, in place of questions asking whether each vehicle is being utilized, questions may, in the case of a magazine, ask whether the person “read the magazine in last several weeks or months”.

Next, in step 2, a data matrix is created.

In the data matrix table, it is preferable that vehicles and brands be arranged on the left side of the table, and that sense-of-values statements be arranged as the matrix headings.

Next, in step 3 factor analysis is executed, factors are selected, factor scores are determined, and each brand and vehicle is plotted in a coordinate space in which factors are taken to be coordinate axes and factor score=0 is taken as the origin.

The number of factors can be selected by the person executing the evaluation (the evaluator). The evaluator also determines the labels of factors. It is normal to assign a label thought to be appropriate to each factor.

Next, in step 4, the angles formed by each brand and vehicle in the coordinate space, and their value distances, are calculated.

In step 5, it is possible, from the angles formed by each brand and vehicle and from value distances, to objectively grasp how to select a vehicle for a brand in question, how to select a brand as an object suitable for commercial advertising in a vehicle, the characteristics of competing brands and competing vehicles, etc.

It is noted that most of the above operations can be performed by computer. By handling the above procedures as a computer program, factor analysis can be performed at an arbitrary area according to the desires of customers, advertising sponsors and others, based on data obtained at arbitrary areas.

FIG. 8 is a block diagram used to explain the above computer operations. FIG. 8 shows an example of this invention, but the scope of this invention is not limited by this block diagram.

In FIG. 8, the central processing unit 11 receives instructions from a controlling program in main memory 12, reads data input from an input device 15 via a common bus 14, creates a data matrix as shown in step 2 of FIG. 2, and stores the result in a file device 13. An example of the output appears in Table 2.

The control program in main memory 12 can be read from computer-readable recording media recording a program which executes one of the methods described in the above 1. through 9., into the main memory 12, either in advance or as convenient.

The central processing device 11 uses the data matrix to execute arithmetic processing for factor analysis, as in step 2 of FIG. 2, and stores the factors, factor scores and other information obtained in the file device 13.

Next, the central processing device 11 uses these factors, factor scores and other information to obtain the angles formed, value distances and other information for each brand and vehicle in the coordinate space shown in FIG. 1, as indicated in step 4 of FIG. 2, and stores the results in the file device 13.

The various files above stored in the file device by the above means can be output as convenient via a printer, recording media drive, display or other output device 16.

A graph plotting each brand and vehicle in the coordinate space can also be output from the factors and factor scores, as indicated in the explanation of step 3 in FIG. 2. FIG. 7 is an example of such output.

Output such as that shown in Table 6 can also be obtained. Using these, an objective grasp of appropriate brands and vehicles as in step 5 of FIG. 2 becomes possible.

### BRIEF DESCRIPTION OF THE DRAWINGS

FIG. 1 is a model diagram showing a comparison of a conventional method and the evaluation method of this invention, introducing the concept of angles;

FIG. 2 is a flowchart which schematically illustrates this invention;

FIG. 3 is a graph showing the relation between cosines and main copy awareness rates;

FIG. 4 is a graph showing the relation between Euclidean distances and main copy awareness rates;

FIG. 5 is a graph showing the relation between value distances and main copy awareness rates;

FIG. 6 is another graph showing the relation between value distances and main copy awareness rates; FIG. 7 is a positioning map for brands and vehicles; and, FIG. 8 is a block diagram which explains this invention.

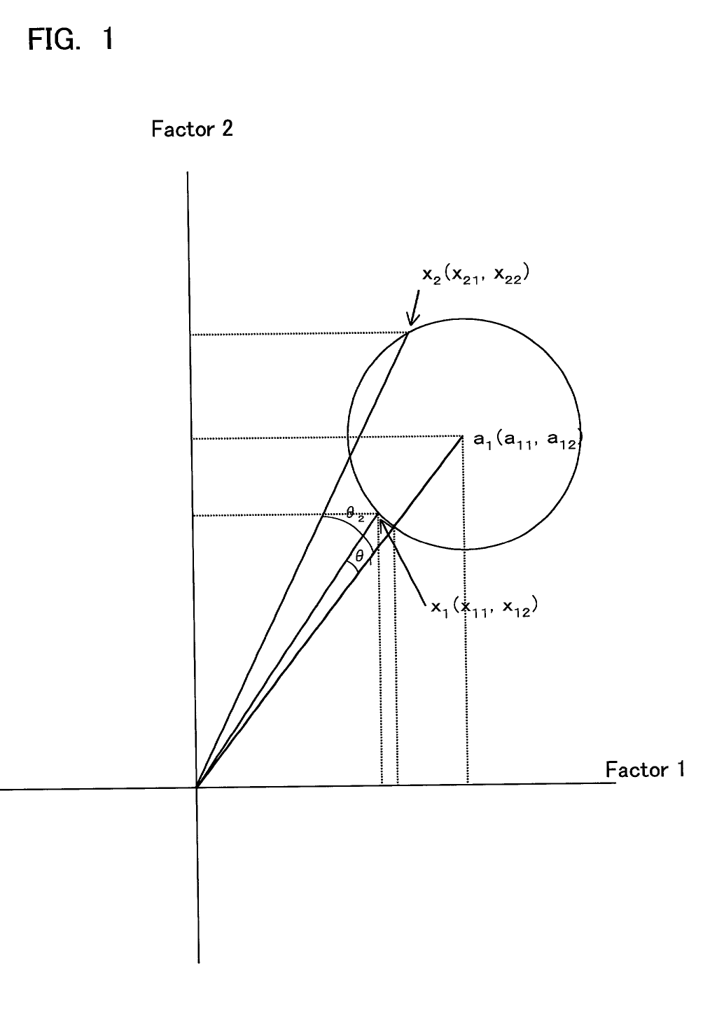

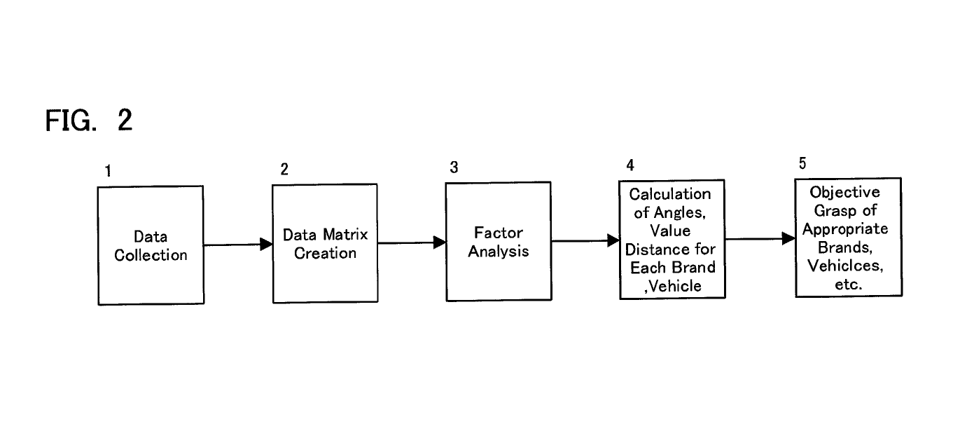

### DESCRIPTION OF THE PREFERRED EMBODIMENTS

Below, one example of an embodiment aspect of this invention is explained, as a more concrete explanation of the above flowchart, regarding the results of application of this invention to a case in which magazines Mg1 through Mg10 are selected as the vehicle group, Br1 through Br5 are selected as the brand group, and the four items at the top of Table 2 (items relating to overseas study and other matters) are selected as the sense-of-values statements.

Table 2 shows a data matrix; in factor analysis, terms (sense-of-values statements) are usually called variables, and vehicles and brands are usually called samples.

It is noted that the following example is no more than one mode of this invention; the scope of this invention is not thereby limited.

The figures enclosed by the side of the table in Table 2 (the column formed by vehicles and brands) and by the table headings (the row formed by sense-of-values statements) are the fractions (in percent), among those persons who have read each vehicle or utilized each brand, who replied in the affirmative with respect to each of the sense-of-values statements. For example, the FIG. “1.9” in the uppermost row on the left end signifies that 1.9% of the persons who have read Mg1 have had overseas study experience.

Table 3 shows the results of factor analysis for sense-of-values statements. The varimax method was used for the factor analysis.

The number of factors which can be obtained in factor analysis using factor analysis methods can be selected arbitrarily, with the total number of variables as the upper limit. Here two were selected, in the order of the largest eigenvalues.

Here an eigenvalue is a value which is the higher, the greater is the explanatory power of a factor with respect to variables which are sense-of-values statements. The contributing ratio is the eigenvalue divided by the number of variables (in this case, four), and the cumulative contributing ratio is the cumulative sum of contributing ratios, in order of magnitude. Concretely, calculations can be performed by the method of Tahenryou Kaiseki no Jissen (jou) (issued Dec. 10, 1993, by Gendai Suugakusha K. K.), pp. 166 to 184.

Table 4 shows factor loadings, which are weightings for each factor with respect to each of the sense-of-values statements.

Factor loadings are calculated by the principal factors method, the centroid method, the maximum likelihood method, and other methods.

The results of Table 4 were obtained using the principal factors method.

Appellations for each of the factors may be determined freely by the evaluator. That is, “degree of status” and “degree of convenience” were selected by the evaluator as appropriate to the respective factors.

Table 5 shows the factor scores for each vehicle and brand.

Factor scores were calculated by the method of minimizing the residual sums of squares.

Based on factor scores obtained in this way, FIG. 7 plots vehicles and brands in the coordinate space taking each factor as a reference axis. Because factor scores may have positive or negative values, it is possible to choose the origin at factor score=0, as in this example.

Table 6 shows Euclidean distances and angles (shown as cosines) between Br1 and each Mg as well as value distances, based on FIG. 7. Value distances were calculated using the above eq. (1) (α=1, β=1).

Next, the results of analyses to verify the validity of this invention are presented. In this analysis, the focus is placed on correlations between the Euclidean distances, cosines, value distances and main copy awareness rates for lipstick brands Br1′, Br2′, Br3′, and magazines Mg1′ through Mg8′ in which advertising for these brands appears.

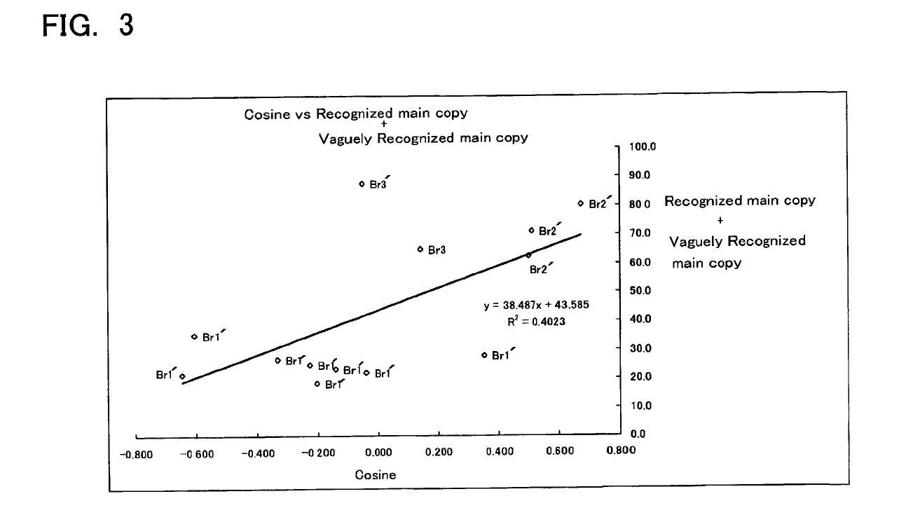

Here “main copy awareness rates” signifies the sum of the fractions, out of all persons responding to a survey questionnaire asking whether the individual remembers main copies for each brand, who recognized or vaguely recognized the main copy. FIGS. 3 through 6 show graphs of the relations between Euclidean distances, cosines, value distances, and main copy awareness rates for each of the lipstick brands Br1′, Br2′, Br3′, and for the magazines in which advertising for these brands appears. In the figures, there are 13 plotted points; this is because, in actuality, advertisements for Br1′ appeared in eight magazines, Mg1′ through Mg8′; advertisements for Br2′ appeared in three magazines, Mg1′, Mg6′, Mg7′; advertisements for Br3′ appeared in two magazines, Mg4′, Mg6′, and, therefore they appeared in a total of thirteen magazines.

In each of the figures, R² is a decision coefficient in correlation equations. Higher values of this decision coefficient signify higher correlation between items on the vertical axis and items on the horizontal axis.

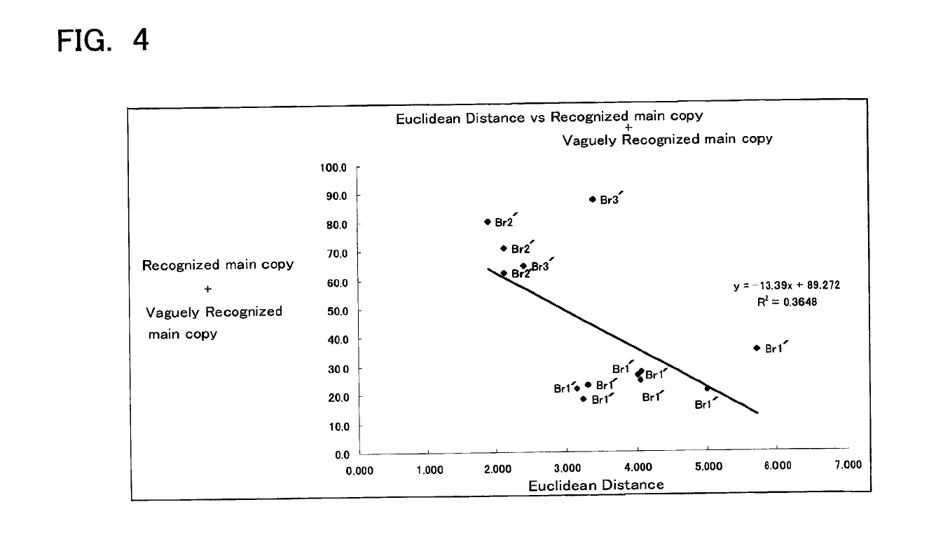

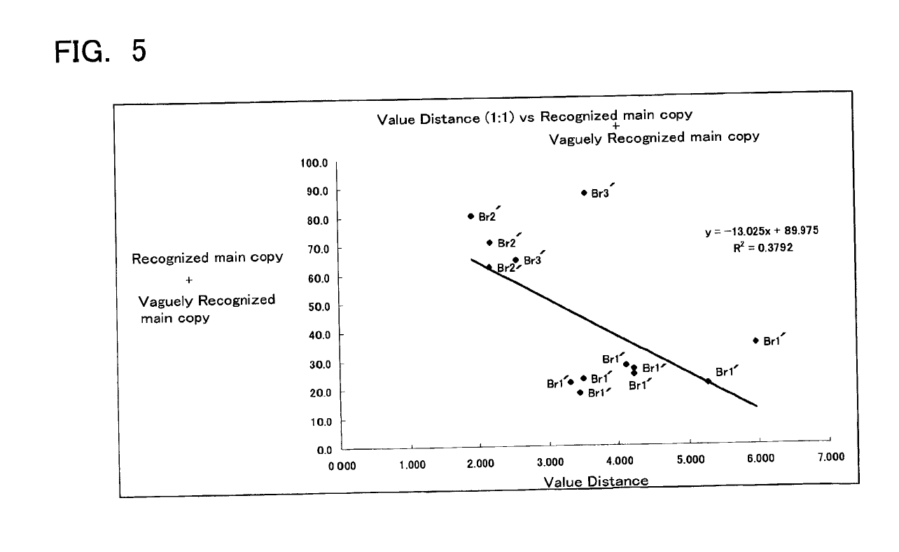

From comparisons of FIG. 3 with FIGS. 4 and 5, it is seen that evaluations using cosines (that is, evaluations using angles), and evaluations using eq. (1), are superior to evaluations using Euclidean distances.

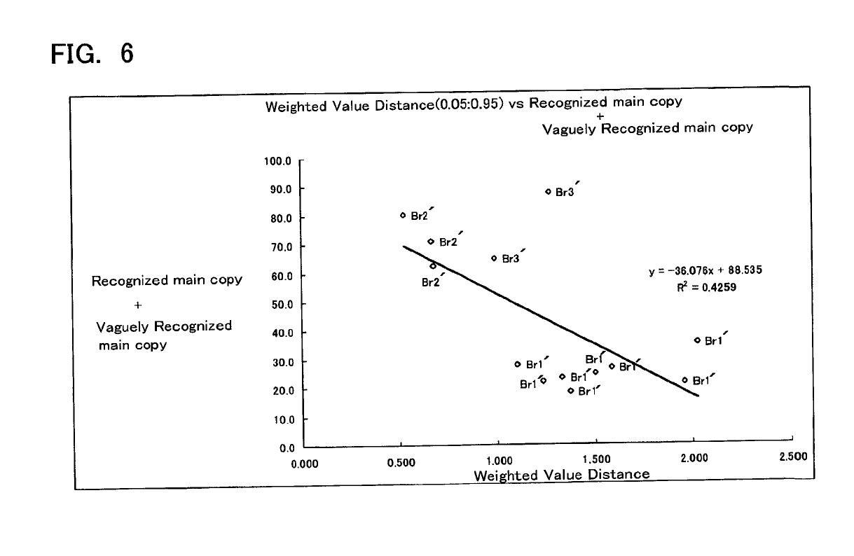

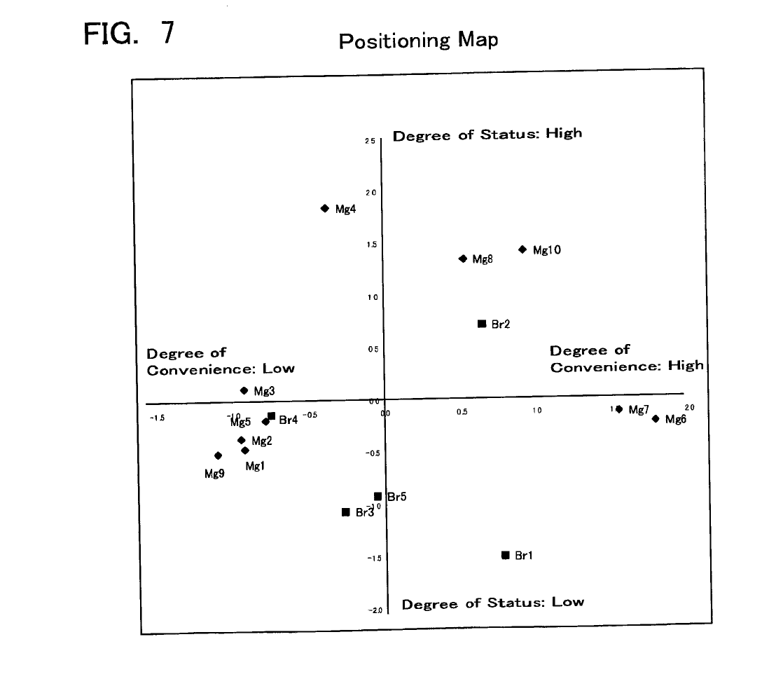

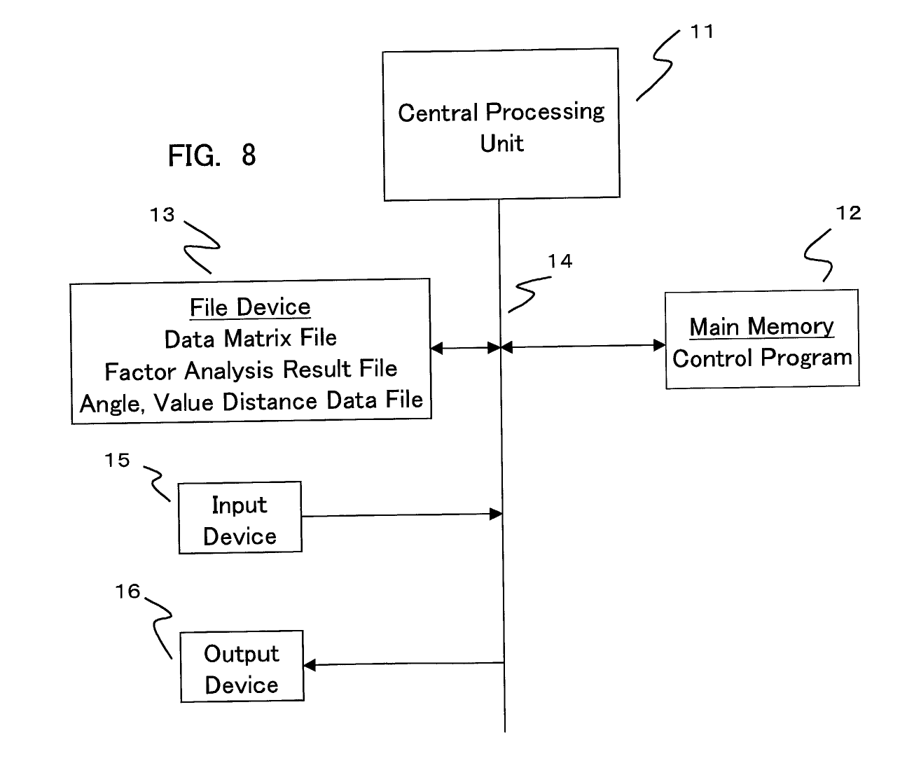

In this evaluation, the decision coefficient of FIG. 5 is smaller than the decision coefficient of FIG. 3. However, in FIG. 6, which replaces the α and β values of FIG. 5 with α=0.05 and β=0.95, the decision coefficient is prominently increased. That is, FIG. 6 indicates that selection of appropriate values for α and β is important for this invention.

With respect to α and β, it has been established that, preferably, 2α≦β. Outside this range, depending on the types of brands and vehicles, there are cases in which effect of an angle is not clearly shown. It was also established that the range α=0.05 to 0.4 and β=0.95 to 0.6 is also preferable. Still more preferable is a range in which both these conditions are satisfied simultaneously.

It has been shown that this invention exhibits superior results for brands of automobiles, cosmetics and alcoholic beverages and for magazine and newspaper vehicles in particular.

By using this invention, it is possible to evaluate the proximity between individual brands, the proximity between individual vehicles, the proximity of individual vehicles to individual brands, and the proximity of individual brands to individual vehicles; in addition, the proximity of individual brands and individual vehicles to specific coordinate positions in a coordinate space constructed from the above factors can be evaluated objectively, rapidly, and with high reliability.

Evaluations of the proximity between brands is useful when evaluating the proximity rank of competing brands to consumer needs, or in a similar case; evaluations of the proximity between vehicles is useful when evaluating the rank of appeal to consumers of competing vehicles, or in a similar case; evaluations of the proximity of a vehicle to individual brands is useful when selecting vehicles compatible with the brands, or in a similar case; and evaluations of the proximity of a brand to individual vehicles is useful when expanding advertising sponsors for the vehicle, or in a similar case. Evaluation of the proximity of individual brands and individual vehicles with respect to specific coordinate positions in a coordinate space constructed from the above factors is useful when setting targets for the development of new brands and vehicles, or in a similar case.

TABLE 1
Examples of sense-of-values statements

| No. | Genre | Statement |
|---|---|---|
| 1 | Health | Visits the hospital (other than dental) |
| | | periodically. |
| 2 | Health | Has strong interest in health. |
| 3 | Health | Pays attention to health of teeth and gums. |
| 4 | Health | Tries not to use medicine. |
| 5 | Health | Takes care not to gain weight. |
| 6 | Health | Always eats breakfast. |
| 7 | Health | Is particular about the taste of food. |
| 8 | Health | Tries to limit fat intake. |
| 9 | Health | Is careful to avoid excessive sugar intake. |
| 10 | Health | Is careful to avoid excessive salt intake. |
| 11 | Eating | Often eats at famous restaurants. |
| 12 | Eating | Often eats fast food. |
| 13 | Eating | Often eats “instant” products. |
| 14 | Eating | Watches intake of additives. |
| 15 | Eating | Knows many good restaurants. |
| 16 | Eating | Visits a discount store for liquor products. |
| 17 | Eating | Sometimes eats carry-out lunches. |
| 18 | Sports | Wants to assemble high-quality sports equipment. |
| 19 | Sports | Likes sports and exercise. |
| 20 | Sports | Wants to get serious about sports. |
| 21 | Sports | Is interested in new sports. |
| 22 | Fashion | Possesses top-brand jewelry or similar. |
| 23 | Fashion | Pays attention to bad breath, other social |
| | | manners. |
| 24 | Fashion | Wants to try looking different from the crowd. |
| 25 | Fashion | Has confidence in own fashion sensibilities. |
| 26 | Fashion | Owns top-brand handbag. |
| 26 | Fashion | Tends to be concerned with others' appearances. |
| 28 | Fashion | Uses specialty stores when buying clothing. |
| 29 | Fashion | Tends to spend money on clothes. |
| 30 | Fashion | Owns top-brand shoes. |
| 31 | Fashion | Spends time on appearance of own face. |
| 32 | Fashion | Tends to be concerned with clothing. |
| 33 | Fashion | Spends time on appearance of hair. |
| 34 | Overseas | Has experience studying overseas. |
| 35 | Overseas | Has read foreign newspaper or similar for 1 |
| | | year. |
| 36 | Overseas | Has two weeks or more experience overseas. |
| 37 | Overseas | Has acquaintances who make frequent trips broad. |
| 38 | Overseas | Wants to study English. |
| 39 | Overseas | Has family or friends living overseas. |
| 40 | Overseas | Can speak English at daily conversational level. |
| 41 | Overseas | Has foreign friends. |
| 42 | Overseas | Has spoken in a foreign language with foreigners |
| | | for 1 year. |
| 43 | Overseas | Wants to study a foreign language other than |
| | | English. |
| 44 | Overseas | Is interested in magazine articles on overseas |
| | | matters. |
| 45 | Overseas | Has traveled abroad. |
| 46 | Overseas | Is interested in overseas reports of newspapers. |
| 47 | Money | Uses money to enjoy living today. |
| 48 | Money | Investigates services of financial institutions. |
| 49 | Money | Tends to save money for the future. |
| 50 | Money | Worries about interest when borrowing money. |
| 51 | Money | Worries about interest when depositing, |
| | | investing money. |
| 52 | Money | Always thinks about social security. |
| 53 | Environment | Participates in a volunteer group or other |
| | | groups. |
| 54 | Environment | Has strong interest in global environment. |
| 55 | Environment | Has strong interest in local environmental |
| | | issues. |
| 56 | Environment | Makes efforts to recycle and protect |
| | | environment. |
| 57 | Environment | Wants to buy environment-friendly products. |
| 58 | Environment | Participates in a hobby, sports group or other |
| | | groups. |
| 59 | Cooking | Often makes bread, candy oneself. |
| 60 | Cooking | Makes food for holidays and festivals |
| | | (Hinamatsuri, Nanakusa, etc.). |
| 61 | Cooking | Prepares meals with nutritional balance in mind. |
| 62 | Cooking | Microwave oven is helpful in making meals. |
| 63 | Cooking | Tries to expand own cooking repertoire. |
| 64 | Cooking | Uses foodstuffs without additives if possible. |
| 65 | Cooking | Uses “instant” and frozen foods without |
| | | worrying. |
| 66 | Cooking | Prepares soup stock from kelp and shaved bonito. |
| 67 | Cooking | Spends time on cooking. |
| 68 | Cooking | Uses good-quality foods for cooking even if |
| | | expensive. |
| 69 | Advertising, | Searches for TV programs to watch. |
| | media, | |
| | information | |
| 70 | Advertising, | Watches only TV programs she/he really wants to |
| | media, | watch. |
| | information | |
| 71 | Advertising, | Watches programs to the end without changing |
| | media, | channels. |
| | information | |
| 72 | Advertising, | Thinks today's TV is enjoyable. |
| | media, | |
| | information | |
| 73 | Advertising, | Often does something else while watching TV. |
| | media, | |
| | information | |
| 74 | Advertising, | Often watches TV alone. |
| | media, | |
| | information | |
| 75 | Advertising, | Often programs a VCR to record programs. |
| | media, | |
| | information | |
| 76 | Advertising, | Usually watches BS satellite broadcast TV. |
| | media, | |
| | information | |
| 77 | Advertising, | Usually watches CS satellite broadcast TV. |
| | media, | |
| | information | |
| 78 | Advertising, | Usually watches cable TV. |
| | media, | |
| | information | |
| 79 | Advertising, | Often does something else while listening to the |
| | media, | radio. |
| | information | |
| 80 | Advertising, | Often listens to the radio while in the car. |
| | media, | |
| | information | |
| 81 | Advertising, | Often listens to the radio at the workplace. |
| | media, | |
| | information | |
| 82 | Advertising, | Listens to the radio while commuting or on the |
| | media, | move. |
| | information | |
| 83 | Advertising, | Tends to listen to specific radio programs. |
| | media, | |
| | information | |
| 84 | Advertising, | Tries to read a number of different |
| | media, | newspapers. |
| | information | |
| 85 | Advertising, | Always reads the morning edition in the morning |
| | media, | of that day. |
| | information | |
| 86 | Advertising, | Often brings up newspaper reportage in |
| | media, | conversations. |
| | information | |
| 87 | Advertising, | Often makes use of newspaper articles in |
| | media, | everyday life. |
| | information | |
| 88 | Advertising, | Tries to buy newly established magazines when |
| | media, | possible. |
| | information | |
| 89 | Advertising, | Often makes use of magazine articles in everyday |
| | media, | life. |
| | information | |
| 90 | Advertising, | Often buys magazines the day they appear on |
| | media, | newsstands. |
| | information | |
| 91 | Advertising, | Often buys magazines at convenience stores. |
| | media, | |
| | information | |
| 92 | Advertising, | Often looks over direct-mail offerings. |
| | media, | |
| | information | |
| 93 | Advertising, | Has strong interest in multimedia. |
| | media, | |
| | information | |
| 94 | Advertising, | Often collects information on the Internet. |
| | media, | |
| | information | |
| 95 | Advertising, | Is interested in ads to find out what's popular |
| | media, | and trendy. |
| | information | |
| 96 | Advertising, | Makes use of ads when shopping. |
| | media, | |
| | information | |
| 97 | Advertising, | Looks closely at ads for interesting products. |
| | media, | |
| | information | |
| 98 | Advertising, | Often looks at ads within trains. |
| | media, | |
| | information | |
| 99 | Advertising, | Often looks at ads and posters in stations. |
| | media, | |
| | information | |
| 100 | Advertising, | Looks at billboards, neon signs in the town. |
| | media, | |
| | information | |
| 101 | Advertising, | Requests literature on seeing ads. |
| | media, | |
| | information | |

TABLE 2
Data matrix

| | | Past experience | Often | Interested | Tends to |
|---|---|---|---|---|---|
| | Magazine | in overseas | eats fast | in new | spend money |
| No. | /brand | study | food | sports | on clothes |
| 1 | Mg1 | 1.9 | 27.1 | 23.0 | 31.6 |
| 2 | Mg2 | 2.4 | 30.8 | 22.5 | 31.2 |
| 3 | Mg3 | 2.7 | 32.5 | 27.1 | 34.2 |
| 4 | Mg4 | 6.6 | 50.8 | 41.8 | 47.1 |
| 5 | Mg5 | 2.2 | 23.0 | 28.4 | 34.6 |
| 6 | Mg6 | 11.3 | 34.3 | 37.3 | 53.7 |
| 7 | Mg7 | 10.8 | 36.1 | 36.3 | 52.0 |
| 8 | Mg8 | 7.5 | 48.1 | 42.0 | 54.3 |
| 9 | Mg9 | 1.4 | 25.8 | 22.1 | 29.7 |
| 10 | Mg10 | 8.9 | 46.9 | 45.5 | 57.7 |
| 1 | Br1 | 5.4 | 18.9 | 23.9 | 41.3 |
| 2 | Br2 | 8.6 | 48.8 | 35.5 | 49.8 |
| 3 | Br3 | 5.0 | 18.8 | 23.5 | 30.7 |
| 4 | Br4 | 4.2 | 35.6 | 24.2 | 32.5 |
| 5 | Br5 | 6.4 | 31.0 | 21.2 | 32.6 |

TABLE 3
Factor analysis results (eigenvalues, contributing
ratios, cumulative contributing ratios)

| | | Contributing | Cumulative |
|---|---|---|---|
| Factor No. | Eigenvalue | ratio | contributing ratio |
| Factor No. 1 | 1.789 | 44.72% | 44.72 % |
| Factor No. 2 | 1.748 | 43.71% | 88.43 % |

TABLE 4
Factor analysis results (factor loading)

| Degree of status | | Degree of convenience | |
|---|---|---|---|
| | 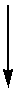 | | 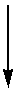 |
| Sense-of-Values | Factor | Sense-of-Values | Factor |
| statement | No. 1 | statement | No. 2 |
| Past experience in | 0.8731 | Often eats fast | 0.8404 |
| overseas study | | food | |
| Tends to spend money | 0.7804 | Interested in new | 0.7768 |
| on clothes | | sports | |
| Interested in new | 0.5724 | Tends to spend | 0.5839 |
| sports | | money on clothes | |
| Often eats fast food | 0.3000 | Past experience in | 0.3124 |
| | | overseas study | |

TABLE 5
Factor analysis results (factor scores)

| Magazine/brand | Factor No. 1 | Factor No. 2 |
|---|---|---|
| Mg1 | −0.928 | −0.450 |
| Mg2 | −0.953 | −0.351 |
| Mg3 | −0.928 | 0.117 |
| Mg4 | −0.379 | 1.850 |
| Mg5 | −0.788 | −0.181 |
| Mg6 | 1.775 | −0.226 |
| Mg7 | 1.535 | −0.134 |
| Mg8 | 0.526 | 1.344 |
| Mg9 | −1.107 | −0.493 |
| Mg10 | 0.922 | 1.418 |
| Br1 | 0.775 | −1.498 |
| Br2 | 0.642 | 0.710 |
| Br3 | −0.280 | −1.055 |
| Br4 | −0.750 | −0.130 |
| Br5 | −0.062 | −0.920 |

TABLE 6
Euclidean distance, cosine, value distance between
Br1 and magazine vehicles
Euclidean distance between brand 1 and magazines

| No. | Magazine | Euclidean distance |
|---|---|---|
| 1 | Mg7 | 1.562 |
| 2 | Mg6 | 1.618 |
| 3 | Mg1 | 1.999 |
| 4 | Mg5 | 2.044 |
| 5 | Mg2 | 2.074 |
| 6 | Mg9 | 2.133 |
| 7 | Mg3 | 2.347 |
| 8 | Mg8 | 2.853 |
| 9 | Mg10 | 2.920 |
| 10 | Mg4 | 3.541 |

Cosine between brand 1 and magazines

| No. | Magazine | Cosine |
|---|---|---|
| 1 | Mg6 | 0.568 |
| 2 | Mg7 | 0.535 |
| 3 | Mg1 | −0.025 |
| 4 | Mg9 | −0.058 |
| 5 | Mg2 | −0.124 |
| 6 | Mg5 | −0.249 |
| 7 | Mg10 | −0.494 |
| 8 | Mg3 | −0.567 |
| 9 | Mg8 | −0.660 |
| 10 | Mg4 | −0.962 |

Value distance between brand 1 and magazines

| No. | Magazine | Value distance |
|---|---|---|
| 1 | Mg7 | 1.630 |
| 2 | Mg6 | 1.675 |
| 3 | Mg1 | 2.247 |
| 4 | Mg2 | 2.359 |
| 5 | Mg9 | 2.381 |
| 6 | Mg5 | 2.396 |
| 7 | Mg3 | 2.822 |
| 8 | Mg10 | 3.280 |
| 9 | Mg8 | 3.300 |
| 10 | Mg4 | 4.049 |

What is claimed is:

1. A method of evaluation of the proximity of a brand and/or a vehicle, based on factors obtained as a result of factor analysis of a brand group and/or a vehicle group, comprising
evaluation of the mutual proximity between brands, or between vehicles, or between a brand and a vehicle, through the magnitude of the angle θ formed by the vectors thereof, in a coordinate system in which a plurality of factors are respectively taken to be axes with the origin taken to be the factor score=0, and the factor score of each brand and/or each vehicle for each factor is expressed as a distance from the origin along the factor axis.

2. The method of evaluation of the proximity of a brand and/or a vehicle according to claim 1, comprising the evaluation of mutual proximity by means of the magnitude of the angle θ made by said vectors and their mutual distance.

3. A method of evaluation of the proximity of a brand and/or a vehicle, based on factors obtained as a result of factor analysis of a brand group and/or a vehicle group, wherein
in a coordinate system in which a plurality of factors are respectively taken to be axes with the origin taken to be the factor score=0, and the factor score of each brand and/or vehicle for each factor is expressed as a distance from the origin along the factor axis, the mutual proximity of a specific brand or vehicle lᵢ and a specific brand or vehicle mⱼ is evaluated by means of equation (1) below.
$${D}_{ij} = {[ α \{ {\sum }_{k = 1}^{n} {( {l}_{ik} - {m}_{jk} )}^{2} \} + {β ( 1 - cos {θ}_{ij} )}^{2} ]}^{1 / 2} \qquad ( 1 )$$
where:
i, j: Numbers assigned to brands or vehicles
Dᵢⱼ: Value distance between brand or vehicle li, and brand or vehicle mⱼ
lᵢₖ: Factor score on the k-factor axis of brand or vehicle lᵢ
mⱼₖ: Factor score on the k-factor axis of brand or vehicle mⱼ
n: Number of factor axes used in evaluation
θᵢⱼ: Angle made by the vectors of the brand or vehicle lᵢ, and the brand or vehicle mⱼ
α, β: Weighting factors, where 0≦α≦1 and 0<β≦1

4. The proximity evaluation method according to claim 3, wherein 2α≦β.

5. The proximity evaluation method according to claim 3, wherein α=0.05 to 0.4, and β=0.95 to 0.6.

6. A method of evaluation of the proximity of a vehicle to a brand, which determines the affinity of each of the vehicles in a selected vehicle group with a specific brand by means of the value distance Dᵢⱼ of claim 3 formed by each of the vehicles of said selected vehicle group and said specific brand.

7. A method of evaluation of the proximity of a brand to a vehicle, which determines the affinity of each of the brands in a selected brand group with a specific vehicle by means of the value distance Dᵢⱼ of claim 3 formed by each of the brands of said selected brand group and said specific vehicle.

8. A method of evaluation of the proximity of a brand to a brand, which determines the proximity of each of the brands in a selected brand group with a specific brand by means of the value distance Dᵢⱼ of claim 3 formed by each of the brands of said selected brand group and said specific brand.

9. A method of evaluation of the proximity of a vehicle to a vehicle, which determines the proximity of each of the vehicles in a selected vehicle group with a specific vehicle by means of the value distance Dᵢⱼ of claim 3 formed by each of the vehicles of said selected vehicle group and said specific vehicle.

10. A method of evaluation of the proximity of a brand and/or a vehicle, based on factors obtained as a result of factor analysis of a brand group and/or a vehicle group,
comprising
evaluation of the mutual proximity between brands or between vehicles through the magnitude of the angle formed by factor scores and a factor axis, in a coordinate system in which a plurality of factors are respectively taken to be axes with the origin taken to be the factor score=0, and the factor score of each brand and/or each vehicle for each factor is expressed as a distance from the origin along the factor axis.

11. The method of evaluation of the proximity of a brand and/or a vehicle according to claim 10, comprising the evaluation of proximity by means of the magnitude of the angle made by factor scores and a factor axis, and the distance between factor scores and the origin.

12. A system for evaluation of the proximity of a brand and/or a vehicle, based on factors obtained as a result of factor analysis of a brand group and/or a vehicle group, comprising
means for determining factor scores of each brand and/or vehicle for each factor of the plural factors, and,
in a coordinate system in which the plural factors are taken to be axes with the origin taken to be the factor score=0, and the factor score of each brand and/or vehicle for each factor is expressed as a distance from the origin along the factor axis, means for generation of the angles of vectors formed between coordinate points determined by the factor scores of each brand and/or each vehicle.

13. A system for evaluation of the proximity of a brand and/or a vehicle, based on factors obtained as a result of factor analysis of a brand group and/or a vehicle group, and having
means for determining factor scores of each brand and/or vehicle for each factor of a plurality of factors, and,
in a coordinate system in which the plural factors are taken to be axes with the origin taken to be the factor score=0, and the factor score of each brand and/or vehicle for each factor is expressed as a distance from the origin along the factor axis, means for generation of the angles formed between coordinate points determined by the factor scores of each brand and/or each vehicle, and factor axes.

14. The system for proximity evaluation according to claim 12, having means for generation of distances between coordinate points and/or distances between coordinate points and the origin.

15. A system for evaluation of the proximity of a brand and/or a vehicle, based on factors obtained as a result of factor analysis of a brand group and/or a vehicle group, and having
means for determining factor scores of each brand and/or vehicle for each factor of a plurality of factors, and,
in a coordinate system in which the plural factors are taken to be axes with the origin taken to be the factor score=0, and the factor score of each brand and/or vehicle for each factor is expressed as a distance from the origin along the factor axis, means for generation of the mutual proximity between a specific brand or vehicle lᵢ and a specific brand or vehicles mⱼ, using equation (1) below.
$${D}_{ij} = {[ α \{ {\sum }_{k = 1}^{n} {( {l}_{ik} - {m}_{jk} )}^{2} \} + {β ( 1 - cos {θ}_{ij} )}^{2} ]}^{1 / 2} \qquad ( 1 )$$
where:
i, j: Numbers assigned to brands or vehicles
Dᵢⱼ: Value distance between brand or vehicle lᵢ, and brand or vehicle mⱼ
lᵢₖ: Factor score on the k-factor axis of brand or vehicle lᵢ
mⱼₖ: Factor score on the k-factor axis of brand or vehicle mⱼ
n: Number of factor axes used in evaluation
θᵢⱼ: Angle made by the vectors of the brand or vehicle lᵢ, and the brand or vehicle mⱼ
α, β: Weighting factors, where 0≦α≦1 and 0<β≦1

16. A computer program product for executing the method according to claim 1 or claim 3.
